(19) United States
(12) Patent Application Publication
(10) Pub. No.: US 2025/0033309 A1
(43) Pub. Date: Jan. 30, 2025

(54) MOLD FOR ULTRA-HIGH PRESSURE GENERATOR

(71) Applicant: Sumitomo Electric Hardmetal Corp., Itami-shi, Hyogo (JP)

(72) Inventors: Syunsuke YAMANAKA, Itami-shi, Hyogo (JP); Eiji YAMAMOTO, Itami-shi, Hyogo (JP); Kazuhiro HIROSE, Itami-shi, Hyogo (JP)

(73) Assignee: Sumitomo Electric Hardmetal Corp., Itami-shi, Hyogo (JP)

(21) Appl. No.: 18/714,137

(22) PCT Filed: Jan. 17, 2022
(86) PCT No.: PCT/JP2022/001397

§ 371 Date: May 29, 2024

(51) Int. Cl. B30B 15/02

(52) U.S. Cl. CPC B30B 15/02

(57) ABSTRACT

A mold for an ultra-high pressure generating device being composed of a cemented carbide, wherein the cemented carbide comprises a first phase being composed of a plurality of tungsten carbide grains and a second phase containing cobalt, wherein the Vickers hardness of the cemented carbide is 2000 Hv or more, wherein the bending strength of the cemented carbide is 2.3 GPa or more, wherein the mold for an ultra-high pressure generating device has a truncation surface, and wherein the compressive residual stress of the truncation surface is 1.50 GPa or more.

### TECHNICAL FIELD

The present disclosure relates to a mold for an ultra-high pressure generating device.

### BACKGROUND ART

Tungsten carbide-cobalt (WC—Co) cemented carbide, which has excellent mechanical properties, is used for molds for ultra-high pressure generating devices (for example, Patent Literatures 1 to 2).

### CITATION LIST

### Patent Literature

PTL 1: Japanese Patent Laying-Open No. 2001-181777
PTL 2: Japanese Patent Laying-Open No. 2008-38242

### SUMMARY OF INVENTION

The present disclosure is a mold for an ultra-high pressure generating device being composed of a cemented carbide, wherein the cemented carbide comprises a first phase being composed of a plurality of tungsten carbide grains and a second phase containing cobalt, a Vickers hardness of the cemented carbide is 2000 Hv or more, a bending strength of the cemented carbide is 2.3 GPa or more, the mold for an ultra-high pressure generating device has a truncation surface, and a compressive residual stress of the truncation surface is 1.50 GPa or more.

### BRIEF DESCRIPTION OF DRAWINGS

FIG. 1 is a schematic diagram showing an example of a mold for an ultra-high pressure generating device according to Embodiment 1.

FIG. 2 is a schematic diagram showing another example of a mold for an ultra-high pressure generating device according to Embodiment 1.

FIG. 3 is a schematic diagram showing another example of a mold for an ultra-high pressure generating device according to Embodiment 1.

### DETAILED DESCRIPTION

### Problem to be Solved by the Present Disclosure

When an ultra-high pressure generating device is used, a very high pressure of up to about 20 GPa is applied to a mold for an ultra-high pressure generating device. Under such an ultra-high pressure, breakage of the mold for an ultra-high pressure generating device is likely to occur, and the lifespan of the mold for an ultra-high pressure generating device tends to decrease. Therefore, there is a demand for a mold for an ultra-high pressure generating device that has a long lifespan even when used under ultra-high pressure.

### Advantageous Effect of the Present Disclosure

The mold for an ultra-high pressure generating device of the present disclosure can have a long lifespan even when used under ultra-high pressure.

### DESCRIPTION OF EMBODIMENTS

First, embodiments of the present disclosure will be listed and described.

(1) The present disclosure is a mold for an ultra-high pressure generating device being composed of a cemented carbide,
wherein the cemented carbide comprises a first phase being composed of a plurality of tungsten carbide grains and a second phase containing cobalt,
wherein the Vickers hardness of the cemented carbide is 2000 Hv or more,
wherein the bending strength of the cemented carbide is 2.3 GPa or more,
wherein the mold for an ultra-high pressure generating device has a truncation surface, and
wherein the compressive residual stress of the truncation surface is 1.50 GPa or more.

The mold for an ultra-high pressure generating device of the present disclosure can have a long lifespan even when used under ultra-high pressure.

(2) The cobalt content of the cemented carbide is preferably 3.0 mass % or more and 8.0 mass % or less. According to this, the lifespan of the mold for an ultra-high pressure generating device is further lengthened.

(3) The tungsten carbide grains preferably have an average grain size of 0.05 μm or more and 0.50 μm or less. According to this, the lifespan of the mold for an ultra-high pressure generating device is further lengthened.

### DETAILS OF EMBODIMENTS OF THE PRESENT DISCLOSURE

Specific examples of the mold for an ultra-high pressure generating device of the present disclosure will be described below with reference to the drawings. The same reference numerals indicate the same or equivalent portions in the figures of the present disclosure. Relation of such a dimension as a length, a width, a thickness, or a depth is modified as appropriate for clarity and brevity of the drawings and does not necessarily represent actual dimensional relation.

In the present specification, the expression “A to B” represents a range of lower to upper limits (i.e., A or more and B or less), and in a case where no unit is indicated for A and a unit is indicated only for B, the unit of A is the same as the unit of B.

In a case where a compound or the like is expressed by a chemical formula in the present specification and an atomic ratio is not particularly limited, it is assumed that all the conventionally known atomic ratios are included, and the atomic ratio is not necessarily limited only to one in the stoichiometric range. For example, in a case where “WC” is described, the atomic ratio in the WC is not limited to W:C=1:1 and includes all the conventionally known atomic ratios. The same also applies to compounds other than the “WC”.

### Embodiment 1: Mold for Ultra-High Pressure Generating Device

One embodiment of the present disclosure (hereinafter also referred to as “the present embodiment”) is a mold for an ultra-high pressure generating device being composed of a cemented carbide,
wherein the cemented carbide comprises a first phase being composed of a plurality of tungsten carbide grains and a second phase containing cobalt,
the Vickers hardness of the cemented carbide is 2000 Hv or more,
the bending strength of the cemented carbide is 2.3 GPa or more,
the mold for an ultra-high pressure generating device has a truncation surface, and
the compressive residual stress of the truncation surface is 1.50 GPa or more.

### <Mold for Ultra-High Pressure Generating Device>

Examples of the mold for an ultra-high pressure generating device of the present embodiment include anvils used for multi-anvil type high pressure generating devices, and anvils used for belt type high pressure devices.

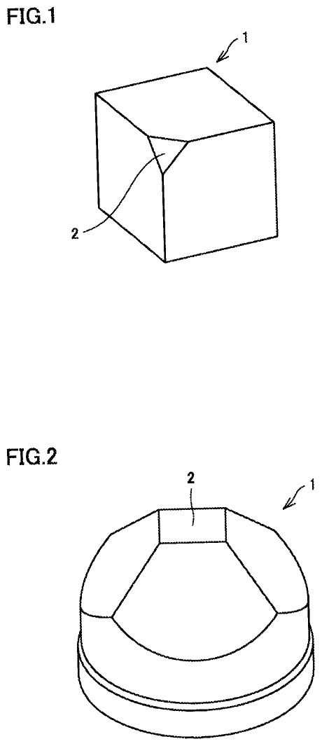

Multi-anvil type high pressure generating devices have a structure in which four or more anvils are driven synchronously to compress the sample body isotropically. Examples of such anvils are shown in FIGS. 1 and 2.

FIG. 1 is a schematic diagram showing an example of an anvil used in a high pressure generating device that uses eight cubic anvils. An anvil 1 in FIG. 1 has the shape of a cube with one of its vertices shaved off, and the surface shaved off forms an equilateral triangular truncation surface 2.

FIG. 2 is a schematic diagram showing an example of an anvil used in a cubic anvil high pressure generating device that uses six anvils. An anvil 1 in FIG. 2 has a square truncation surface 2.

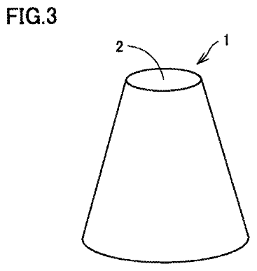

Belt type high pressure generating devices have a structure in which the sample body is placed in a cylinder and pressurized by opposing anvils. An example of such anvils is shown in FIG. 3. As shown in FIG. 3, such an anvil 1 has a truncated cone shape. The top surface of such a truncated cone corresponds to a truncation surface 2.

In the present specification, the truncation surface means, of the surfaces of the mold, the surface that applies pressure to the workpiece. The shape of the mold for an ultra-high pressure generating device of the present embodiment and the shape of the truncation surface are not limited to the shapes shown in FIGS. 1 to 3, and may be any of the shapes conventionally known.

### <Cemented Carbide>

The cemented carbide that forms the mold for an ultra-high pressure generating device of the present embodiment comprises a first phase being composed of a plurality of tungsten carbide grains and a second phase containing cobalt.

### First Phase

In the present embodiment, the first phase of the cemented carbide is composed of a plurality of tungsten carbide grains (hereinafter also referred to as “WC grains”). In the present embodiment, the first phase corresponds to a hard phase. In addition to tungsten carbide, the tungsten carbide grains of the first phase may contain unavoidable impurity elements and a trace amount of impurity elements that are mixed in the manufacturing process of the WC grains, or the like, as long as the effects of the present disclosure are exhibited. Examples of the unavoidable impurity elements and impurity elements described above (hereinafter, the unavoidable impurity elements and impurity elements are also collectively referred to as “first impurity elements”) include molybdenum (Mo) and chromium (Cr). The content of the first impurity elements in the first phase (the total content in a case where there are two or more impurity elements) is preferably less than 0.1 mass %. The content of the first impurity elements in the first phase is measured by inductively coupled plasma (ICP) emission spectrometry (measurement device: “ICPS-8100”™ manufactured by Shimadzu Corporation).

It is preferable that the first phase is composed of a plurality of tungsten carbide grains, and that the content of the first impurity elements in the first phase is less than 0.1 mass %. It is preferable that the first phase is composed of a plurality of tungsten carbide grains, and that the content of tungsten carbide in the first phase is more than 99.9 mass % and that the content of the first impurity elements in the first phase is less than 0.1 mass %. It is preferable that the first phase is composed of a plurality of tungsten carbide grains, and that the content of tungsten carbide in the first phase is more than 99.9 mass % and 100 mass % or less and the content of the first impurity elements in the first phase is 0 mass % or more and less than 0.1 mass %.

### <<Average Grain Size of Tungsten Carbide Grains>>

In the present embodiment, the tungsten carbide grains preferably have an average grain size of 0.05 μm or more and 0.50 μm or less. According to this, the hardness of the cemented carbide is improved and the lifespan of the mold for an ultra-high pressure generating device is improved. In the present specification, the average grain size of the tungsten carbide grains means the number-based arithmetic mean size of circular equivalent diameter of tungsten carbide grains observed in the cross section of the cemented carbide.

The lower limit of the average grain size of the tungsten carbide grains is preferably 0.05 μm or more, more preferably 0.10 μm or more, from the viewpoint of feasibility in production. The upper limit of the average grain size of the tungsten carbide grains is preferably 0.50 μm or less, more preferably 0.4 μm or less, and still more preferably 0.3 μm or less, from the viewpoint of improving the Vickers hardness. The average grain size of the tungsten carbide grains is preferably 0.05 μm or more and 0.50 μm or less, preferably 0.05 m or more and 0.40 μm or less, preferably 0.05 μm or more and 0.30 μm or less, preferably 0.10 μm or more and 0.50 μm or less, preferably 0.10 μm or more and 0.40 μm or less, and preferably 0.110 μm or more and 0.30 μm or less.

The average grain size of the WC grains is measured by the following procedure. The cemented carbide is subjected to a cross section polisher (CP) process using an argon ion beam or the like, thereby obtaining a sample having a smooth cross section. The cross section is imaged using a field emission scanning electron microscope (FE-SEM, trade name: “JSM-7800F” manufactured by JEOL), to obtain a backscattered electron image (SEM-BSE image) of the cross section. The imaging conditions are an imaging magnification of 5000 times, an acceleration voltage of 5 kV, and a work distance of 10.0 mm.

A measurement field of 1 mm² (1 mm×1 mm rectangle) is arbitrarily set in the backscattered electron image. The outer edge of each WC grain in the measurement field is specified by using image analysis software (ImageJ ver. 1.51j8 (https://imagej.nih.gov/ij/)), and the circular equivalent diameter of each WC grain is calculated. A number-based arithmetic mean size of circular equivalent diameter of all WC grains in the measurement field is defined as the average grain size of the WC grains in the measurement filed. The measurement is performed at five different measurement fields. The average value of the average grain sizes of the WC grains in the five measurement fields is calculated. This average value corresponds to the average grain size of the WC grains in the present embodiment.

As far as the applicant has measured, it has been confirmed that, as long as measurement is performed on the same sample, even if these measurements are performed a plurality of times by changing the selected portion of the measurement field, there is little variation in the measurement results, and even if the measurement field is arbitrarily set, the measurement does not become arbitrary.

### Second Phase

In the present embodiment, the second phase of the cemented carbide contains cobalt (Co). In the present embodiment, the second phase corresponds to a binder phase. In addition to cobalt, the second phase may contain chromium (Cr), vanadium (V), unavoidable impurity elements, and the like. Examples of the unavoidable impurity elements (hereinafter also referred to as “second impurity elements”) include iron (Fe), nickel (Ni), manganese (Mn), magnesium (Mg), calcium (Ca), molybdenum (Mo), sulfur (S), titanium (Ti), and aluminum (Al). The cobalt content of the second phase is preferably more than 99 mass % and 100 mass % or less. The total content of chromium, vanadium, and the second impurity elements in the second phase is preferably 0 mass % or more and less than 1 mass %. The total content of chromium, vanadium, and the second impurity elements in the second phase is measured by inductively coupled plasma (ICP) emission spectrometry (measurement device: “ICPS-8100”™ manufactured by Shimadzu Corporation).

It is preferable that the second phase is composed of cobalt and at least any selected from the group consisting of chromium, vanadium, and the second impurity elements, and the total content of chromium, vanadium, and that the second impurity elements in the second phase is less than 1 mass %. It is preferable that the second phase is composed of cobalt and at least any selected from the group consisting of chromium, vanadium, and the second impurity elements, and that the cobalt content of the second phase is more than 99 mass % and the total content of chromium, vanadium, and the second impurity elements in the second phase is less than 1 mass %. It is preferable that the second phase contains cobalt, and that the cobalt content of the second phase is more than 99 mass % and 100 mass % or less and the total content of chromium, vanadium, and the second impurity elements in the second phase is 0 mass % or more and less than 1 mass %.

### Third Phase

In the present embodiment, the cemented carbide may comprise, in addition to the first and second phases, another phase (also referred to as “third phase” in the present specification), as long as the effects of the present disclosure are exhibited. Examples of components constituting the third phase include concentrated phases of chromium (Cr), vanadium (V), and carbon (C) derived from Cr₃C₂ and VC, which are added as grain growth inhibitors in the production process of cemented carbide.

### <<Composition of Cemented Carbide>>

In the present embodiment, the content of the first phase in the cemented carbide is preferably 80.0 vol % or more and 98.0 vol % or less. According to this, the cemented carbide can have high hardness and high bending strength. The lower limit of the content of the first phase in the cemented carbide is preferably 81.0 vol % or more, more preferably 82.0 vol % or more, and still more preferably 83.0 vol % or more, from the viewpoint of improving the hardness of the cemented carbide. The upper limit of the content of the first phase in the cemented carbide is preferably 97.0 vol % or less, more preferably 96.0 vol % or less, and still more preferably 95.0 vol % or less, from the viewpoint of improving the bending strength of the cemented carbide. The content of the first phase in the cemented carbide is preferably 81.0 vol % or more and 97.0 vol % or less, more preferably 82.0 vol % or more and 96.0 vol % or less, and still more preferably 83.0 vol % or more and 95.0 vol % or less.

In the present embodiment, the content of the second phase in the cemented carbide is preferably 2.0 vol % or more and 20.0 vol % or less. According to this, the cemented carbide can have high hardness and high bending strength. The lower limit of the content of the second phase in the cemented carbide is preferably 3.0 vol % or more, more preferably 4.0 vol % or more, and still more preferably 5.0 vol % or more, from the viewpoint of improving the bending strength of the cemented carbide. The upper limit of the content of the second phase in the cemented carbide is preferably 19.0 vol % or less, more preferably 18.0 vol % or less, and still more preferably 17.0 vol % or less, from the viewpoint of improving the hardness of the cemented carbide. The content of the second phase in the cemented carbide is preferably 3.0 vol % or more and 19.0 vol % or less, more preferably 4.0 vol % or more and 18.0 vol % or less, and still more preferably 5.0 vol % or more and 17.0 vol % or less.

In the present embodiment, it is preferable that the cemented carbide comprises the first phase and the second phase, and that the content of the first phase is 80.0 vol % or more and 98.0 vol % or less and the content of the second phase is 2.0 vol % or more and 20.0 vol % or less in the cemented carbide. It is more preferable that the content of the first phase is 81.0 vol % or more and 97.0 vol % or less and the content of the second phase is 3.0 vol % or more and 19.0 vol % or less, and it is still more preferable that the content of the first phase is 82.0 vol % or more and 96.0 vol % or less and the content of the second phase is 4.0 vol % or more and 18.0 vol % or less.

In the present embodiment, it is preferable that the cemented carbide is composed of the first phase and the second phase, and that the content of the first phase is 80.0 vol % or more and 98.0 vol % or less and the content of the second phase is 2.0 vol % or more and 20.0 vol % or less in the cemented carbide. It is more preferable that the content of the first phase is 81.0 vol % or more and 97.0 vol % or less and the content of the second phase is 3.0 vol % or more and 19.0 vol % or less, and it is still more preferable that the content of the first phase is 82.0 vol % or more and 96.0 vol % or less and the content of the second phase is 4.0 vol % or more and 18.0 vol % or less.

In the present embodiment, it is preferable that the cemented carbide is composed of the first phase, the second phase, and unavoidable impurities, and that the content of the first phase is 80.0 vol % or more and 98.0 vol % or less and the content of the second phase is 2.0 vol % or more and 20.0 vol % or less in the cemented carbide. It is more preferable that the content of the first phase is 81.0 vol % or more and 97.0 vol % or less and the content of the second phase is 3.0 vol % or more and 19.0 vol % or less, and it is still more preferable that the content of the first phase is 82.0 vol % or more and 96.0 vol % or less and the content of the second phase is 4.0 vol % or more and 18.0 vol % or less.

In the present embodiment, the content of the third phase in the cemented carbide is preferably 0 vol % or more and 0.5 vol % or less, more preferably 0 vol % or more and 0.3 vol % or less, and most preferably 0 vol %, from the viewpoint of suppressing the occurrence of fracture starting from the third phase and improving the bending strength of the cemented carbide. That is, it is preferable that the cemented carbide does not comprise the third phase, and is composed of the first phase and the second phase.

In the present embodiment, it is preferable that the cemented carbide comprises the first phase, the second phase, and the third phase, and that the content of the first phase is 80.0 vol % or more and less than 98.0 vol %, the content of the second phase is 2.0 vol % or more and less than 20.0 vol %, and the content of the third phase is more than 0 vol % and 0.5 vol % or less in the cemented carbide. It is more preferable that the content of the first phase is 80.0 vol % or more and less than 98.0 vol %, the content of the second phase is 2.0 vol % or more and less than 20.0 vol %, and the content of the third phase is more than 0 vol % and 0.3 vol % or less, and it is still more preferable that the content of the first phase is 80.0 vol % or more and less than 98.0 vol %, the content of the second phase is 2.0 vol % or more and less than 20.0 vol %, and the content of the third phase is more than 0 vol % and 0.1 vol % or less.

In the present embodiment, it is preferable that the cemented carbide is composed of the first phase, the second phase, and the third phase, and that the content of the first phase is 80.0 vol % or more and less than 98.0 vol %, the content of the second phase is 2.0 vol % or more and less than 20.0 vol %, and the content of the third phase is more than 0 vol % and 0.5 vol % or less in the cemented carbide. It is more preferable that the content of the first phase is 80.0 vol % or more and less than 98.0 vol %, the content of the second phase is 2.0 vol % or more and less than 20.0 vol %, and the content of the third phase is more than 0 vol % and 0.3 vol % or less, and it is still more preferable that the content of the first phase is 80.0 vol % or more and less than 98.0 vol %, the content of the second phase is 2.0 vol % or more and less than 20.0 vol %, and the content of the third phase is more than 0 vol % and 0.1 vol % or less.

In the present embodiment, it is preferable that the cemented carbide is composed of the first phase, the second phase, the third phase, and unavoidable impurities, and that the content of the first phase is 80.0 vol % or more and less than 98.0 vol %, the content of the second phase is 2.0 vol % or more and less than 20.0 vol %, and the content of the third phase is more than 0 vol % and 0.5 vol % or less in the cemented carbide. It is more preferable that the content of the first phase is 80.0 vol % or more and less than 98.0 vol %, the content of the second phase is 2.0 vol % or more and less than 20.0 vol %, and the content of the third phase is more than 0 vol % and 0.3 vol % or less, and it is still more preferable that the content of the first phase is 80.0 vol % or more and less than 98.0 vol %, the content of the second phase is 2.0 vol % or more and less than 20.0 vol %, and the content of the third phase is more than 0 vol % and 0.1 vol % or less.

In the present specification, the method for measuring the content of the first phase, the content of the second phase, and the content of the third phase in the cemented carbide is as follows.

The cemented carbide is subjected to a cross section polisher (CP) process using an argon ion beam or the like, thereby obtaining a sample having a smooth cross section. The cross section is imaged using a field emission scanning electron microscope (FE-SEM, trade name: “JSM-7800F” manufactured by JEOL), to obtain a backscattered electron image (SEM-BSE image) of the cross section. The imaging conditions are an imaging magnification of 10000 times, an acceleration voltage of 5 kV, and a work distance of 10.0 mm. In the backscattered electron image, the first phase is shown in light gray, and the second phase is shown in dark gray. In the backscattered electron image, the third phase is indistinguishable from the second phase because they are almost the same color. Thus, in a case where the cemented carbide comprises the third phase, both the second phase and the third phase are shown in dark gray.

A measurement field of 101 μm² (11.88 μm×8.5 μm rectangle) is set in the backscattered electron image.

Next, binarization processing is performed using image analysis software (ImageJ ver. 1.51j8 (https.//imagej.nih.gov/ij/)). The binarization processing is performed in the following procedures (a) to (d) in the initial setting state of the image analysis software.
(a) Edit→Invert
(b) After above (a), Process→Binary→Make Binary
(c) After above (b), Process→Noise→Despeckle. (c) is repeated three times.
(d) After above (c), Process→Binary→Watershed

In the image after the binarization processing, the first phase is shown in light gray, and the second phase is shown in dark gray. In a case where the cemented carbide comprises the third phase, the third phase is shown in dark gray, as is the second phase. It can be confirmed by SEM-EDX (energy dispersive X-ray spectroscopy) that light gray regions are the first phase containing the tungsten carbide grains and dark gray regions are the second phase containing cobalt, or the second phase and the third phase.

Using the above image analysis software on the image after the binarization processing, the sum (total area) of the areas of all the first phases (light gray regions) in the measurement field is calculated. The percentage of the total area of the first phases in the measurement field is calculated to obtain the area ratio of the first phase in the measurement field.

In the backscattered electron image, five measurement fields are arbitrarily set so that there are no overlapping portions, and the area ratio of the first phase is measured in each measurement field. The average value of the area ratio of the first phase in the five measurement fields is calculated. This average value corresponds to the content (vol %) of the first phase in the cemented carbide in the present embodiment.

Using the above image analysis software on the image after the binarization processing, the sum (total area) of the areas of all the second phases (dark gray regions) in the measurement field is calculated. The percentage of the total area of the second phases in the measurement field is calculated to obtain the area ratio of the second phase in the measurement field.

In the backscattered electron image, five measurement fields are arbitrarily set so that there are no overlapping portions, and the area ratio of the second phase is measured in each measurement field. The average value of the area ratio of the second phase in the five measurement fields is calculated. This average value corresponds to the content (vol %) of the second phase in the cemented carbide in the present embodiment.

In a case where the cemented carbide comprises the third phase, the contents of the second phase and the third phase are measured and calculated by the following procedure.

Using the above image analysis software on the image after the binarization processing, the sum (total area) of the areas of all the second phases and the third phases (dark gray regions) in the measurement field is calculated. The percentage of the total area of the second phases and the third phases in the measurement field is calculated to obtain the total area ratio of the second phase and the third phase in the measurement field.

In the backscattered electron image, five measurement fields are arbitrarily set so that there are no overlapping portions, and the area ratio of the second phase and the third phase is measured in each measurement field. The average value of the area ratio of the second phase and the third phase in the five measurement fields is calculated. This average value corresponds to the total content (vol %) of the second phase and the third phase in the cemented carbide in the present embodiment.

The content (vol %) of the third phase in the cemented carbide can be obtained by measuring the amount of solid solution of atoms constituting the third phase into cobalt constituting the second phase and calculating the amount of precipitation of such atoms. For example, the amount of solid solution into cobalt is 5% for chromium (Cr) and 0.2% for vanadium (V). In the above calculation, the cobalt content in the second phase is considered to be 100 mass %. The amount of solid solution of atoms constituting the third phase into cobalt is measured by the following method. The cemented carbide is pulverized to obtain a cemented carbide powder (hereinafter referred to as “sample for measurement”). 0.2 g of the sample for measurement is dissolved (220° C.×1 h) in 20 ml of a solution formed by mixing a 35% hydrochloric acid and water at a volume ratio of 1:1 to obtain a solution. After filtration of the solution, the concentration of Cr and V are analyzed by ICP. The concentration of Cr corresponds to the amount of solid solution of Cr into cobalt. The concentration of V corresponds to the amount of solid solution of V into cobalt.

By subtracting the content (vol %) of the third phase from the total content (vol %) of the second phase and the third phase, the content (vol %) of the second phase in the cemented carbide can be obtained.

As far as the applicant has measured, it has been confirmed that, as long as measurement is performed on the same sample, even if these measurements are performed a plurality of times by changing the selected portion of the measurement field, there is little variation in the measurement results, and even if the measurement field is arbitrarily set, the measurement does not become arbitrary.

### <<Cobalt Content>>

In the present embodiment, the cobalt content of the cemented carbide is preferably 3.0 mass % or more and 8.0 mass % or less. According to this, the cemented carbide can have excellent toughness. From the viewpoint of improving toughness, the lower limit of the cobalt content of the cemented carbide is preferably 3.0 mass % or more, more preferably 4.0 mass % or more, and still more preferably 5.0 mass % or more. From the viewpoint of improving abrasion resistance, the upper limit of the cobalt content of the cemented carbide is preferably 8.0 mass % or less, more preferably 7.5 mass % or less, and still more preferably 7.0 mass % or less. From the viewpoint of improving toughness and abrasion resistance, the cobalt content of the cemented carbide is preferably 3.0 mass % or more and 8.0 mass % or less, more preferably 4.0 mass % or more and 7.5 mass % or less, and still more preferably 5.0 mass % or more and 7.0 mass % or less.

The cobalt content of the cemented carbide can be obtained by analysis by TAS 0054:2017 cobalt potentiometric titration method for cemented carbide.

### <<Vickers Hardness>>

In the present embodiment, the Vickers hardness of the cemented carbide is 2000 Hv or more. According to this, the lifespan of the mold for an ultra-high pressure generating device is improved. From the viewpoint of improving the lifespan of the mold for an ultra-high pressure generating device, the lower limit of the Vickers hardness is 2000 Hv or more, more preferably 2050 Hv or more, and still more preferably 2100 Hv or more. The upper limit of the Vickers hardness is not particularly restricted, but may be 3000 Hv or less from the viewpoint of production. From the viewpoint of improving the lifespan of the mold for an ultra-high pressure generating device, the Vickers hardness of the cemented carbide is preferably 2000 Hv or more and 3000 Hv or less, more preferably 2050 Hv or more and 3000 Hv or less, and still more preferably 2100 Hv or more and 3000 Hv or less.

The method for measuring the Vickers hardness is as follows. A mold for an ultra-high pressure generating device being composed of the cemented carbide is subjected to a cross section polisher (CP) process using an argon ion beam or the like, thereby approximately dividing the mold for an ultra-high pressure generating device into two parts to expose a smooth cross section composed of the cemented carbide. The center of the cross section is used as the measurement location. The center of the cross section means the region with a distance of 5 mm or less from the center of gravity of the cross section. The Vickers hardness of the measurement location is measured in accordance with JIS Z 2244:2009 Vickers hardness test—Test method. The measurement conditions are room temperature (23° C.±5° C.), test load of 294.2 N (30 kgf, Hv30), and holding time of 20 seconds.

### <<Bending Strength>>

In the present embodiment, the bending strength of the cemented carbide is 2.3 GPa or more. According to this, the lifespan of the mold for an ultra-high pressure generating device is improved. From the viewpoint of improving the lifespan of the mold for an ultra-high pressure generating device, the lower limit of the bending strength is 2.3 GPa or more, more preferably 2.7 GPa or more, and still more preferably 3.0 GPa or more. The upper limit of the bending strength is not particularly limited, but may be 6.0 GPa or less from the viewpoint of production. From the viewpoint of improving the lifespan of the mold for an ultra-high pressure generating device, the bending strength of the cemented carbide is preferably 2.3 GPa or more and 6.0 GPa or less, more preferably 2.7 GPa or more and 6.0 GPa or less, and still more preferably 3.0 GPa or more and 6.0 GPa or less.

The bending strength is measured in accordance with CIS026B-2007 Cemented Carbide Bending Strength Test Method. The test piece size is 4 mm×8 mm×25 mm, the load point/fulcrum size is R2.0 mm, and the fulcrum span is 20 mm.

### <<Compressive Residual Stress of Truncation Surface>>

As shown in FIGS. 1 to 3, mold for an ultra-high pressure generating device 1 has truncation surface 2, and the compressive residual stress of the truncation surface is 1.50 GPa or more. According to this, the truncation surface is strengthened and the occurrence of cracks is suppressed, thus improving the lifespan of the mold for an ultra-high pressure generating device. From the viewpoint of improving the lifespan of the mold for an ultra-high pressure generating device, the lower limit of the compressive residual stress is 1.50 GPa or more, more preferably 1.80 GPa or more, and still more preferably 2.00 GPa or more. The upper limit of the compressive residual stress is not particularly limited, but may be 3.00 GPa or less from the viewpoint of production. From the viewpoint of improving the lifespan of the mold for an ultra-high pressure generating device, the compressive residual stress of the truncation surface of the mold for an ultra-high pressure generating device is preferably 1.50 GPa or more and 3.00 GPa or less, more preferably 1.80 GPa or more and 3.00 GPa or less, and still more preferably 2.00 GPa or more and 3.00 GPa or less.

The compressive residual stress of the truncation surface of the mold for an ultra-high pressure generating device is measured using the cos α method. In the cos α method, the truncation surface of the mold for an ultra-high pressure generating device is irradiated with X-rays, and the diffraction phenomenon is used to measure the crystal lattice strain, thereby measuring the compressive residual stress of the truncation surface. As the measurement device, “Portable X-ray Residual Stress Analyzer p-X360s” manufactured by Pulstec Industrial Co., Ltd. can be used. The measurement conditions are as follows.

X-ray tube target: V
Peak used: WC (111)

As for the parameters in the measurement device, the Young's modulus is 534.4 GPa and the Poisson's ratio is 0.220.

### Embodiment 2: Method for Producing Mold for Ultra-High Pressure Generating Device

The mold for an ultra-high pressure generating device of the present embodiment can be produced, for example, by the following method. The mold for an ultra-high pressure generating device of the present embodiment may also be produced by methods other than the following.

The mold for an ultra-high pressure generating device of the present embodiment can be produced by performing a raw material powder preparation step, a mixing step, a molding step, a sintering step, a cooling step, and a compressive residual stress imparting step in the order described above. Each step will be described below.

### <<Preparation Step>>

The preparation step is a step of preparing raw material powders of the cemented carbide. As the raw material powders, tungsten carbide powder as the raw material of the first phase, cobalt (Co) powder as the raw material of the second phase, and chromium carbide (Cr₃C₂) powder and vanadium carbide (VC) powder are prepared as the grain growth inhibitor. Commercially available tungsten carbide powder, cobalt powder, chromium carbide powder, and vanadium carbide powder can be used.

As the tungsten carbide powder, it is preferable to use tungsten carbide powder carbonized at a temperature of 1400° C. or more and 1600° C. or less. The grain size of the tungsten carbide powder is preferably about 0.1 to 0.3 μm. According to this, the stability of WC grains is enhanced at the stage of liquid phase appearance during sintering, so that dissolution and reprecipitation of tungsten carbide are suppressed. Then, the cemented carbide structure becomes finer, and hardness and strength are improved. In the present specification, unless otherwise specified, the average grain size of the raw material powder means an average grain size measured by Fisher Sub-Sieve Sizer (FSSS) method (measurement device: “Fisher Sub-Sieve Sizer Model 95”™ manufactured by Fisher Scientific International, Inc.). The average grain size of the cobalt powder may be 0.4 μm or more and 1.0 μm or less (FSSS method). The average grain size of the chromium carbide powder may be 0.5 μm or more and 3 μm or less (FSSS method). The average grain size of the vanadium carbide powder may be 0.5 μm or more and 3 μm or less (FSSS method).

### <<Mixing Step>>

The mixing step is a step of mixing each raw material powder prepared in the preparation step. A mixed powder in which each raw material powder is mixed is obtained by the mixing step.

The content of the tungsten carbide powder in the mixed powder may be, for example, 89.0 mass % or more and 96.9 mass % or less.

The content of the cobalt powder in the mixed powder may be, for example, 3.0 mass % or more and 8.0 mass % or less.

The content of the chromium carbide powder in the mixed powder may be, for example, 0.1 mass % or more and 2.0 mass % or less.

The content of the vanadium carbide powder in the mixed powder may be, for example, 0.02 mass % or more and 1.0 mass % or less.

The mixed powder is mixed using a ball mill. The media diameter may be 1 mm to 10 mm. The rotation speed may be 10 to 120 rpm. Mixing time may be from 20 hours or more and 48 hours or less.

After the mixing step, the mixed powder may be granulated as necessary. By granulating the mixed powder, it is easy to fill the mixed powder into a die or mold during the molding step described below. A known granulation method can be applied for granulation, and for example, a commercially available granulator such as a spray dryer can be used.

### <<Molding Step>>

The molding step is a step of molding the mixed powder obtained in the mixing step into a predetermined shape to obtain a molded body. The molding method and molding conditions in the molding step are not particularly limited as long as general methods and conditions may be employed. Examples of the predetermined shape include the shape of anvils, such as a cube and a truncated cone.

### <<Sintering Step>>

The sintering step is a step of sintering the molded body obtained in the molding step to obtain a cemented carbide. The sintering conditions can be in vacuum, a sintering temperature of 1340 to 1450° C., and a sintering time of 30 to 180 minutes. According to this, generation of coarse tungsten carbide grains is suppressed. After the sintering step, HIP treatment (hot isostatic pressing) may be performed.

### <<Cooling Step>>

The cooling step is a step of cooling the cemented carbide after completion of sintering. The cooling rate is preferably 2° C./min to 4° C./min. According to this, abnormal grain growth is suppressed.

### <<Compressive Residual Stress Imparting Step>>

The compressive residual stress imparting step is a step of imparting compressive residual stress to the truncation surface of a mold for a high pressure generating device being composed of the cemented carbide. In a case where the shape of the cemented carbide after the cooling step is a cube or the like and it has no truncation surface, one of the vertices is cut off using an electrical discharge machine to form a truncation surface. In a case where the shape of the cemented carbide is a truncated cone, the top surface corresponds to the truncation surface.

Examples of the method for imparting compressive residual stress to the truncation surface include grinding process, shot blasting, and shot peening to the truncation surface.

In the above grinding process, a diamond grinding wheel (for example, #200 grade) is used to grind the truncation surface at an ultra-high speed under the conditions of a cutting depth of 6 μm or more and a feed rate of 400 mm/min or more. This can impart a compressive residual stress of 1.50 GPa or more to the truncation surface.

In the conventional grinding process, the truncation surface has been ground under the conditions of a cutting depth of 2 μm to 3 μm and a feed rate of 50 mm/min to 100 mm/min due to the constraints by the shape of the workpiece (mold for a high pressure generating device) and the shape of the grinding device. According to the conditions described above, the compressive residual stress imparted to the truncation surface is less than 1.50 GPa.

As a result of careful examination, the present inventors have realized grinding conditions with a peripheral speed of 60 m/s or more by using a grinding machine that enables the ultra-high speed grinding process described above. Meanwhile, increasing the peripheral speed raises the temperature of the workpiece, causing a decrease in compressive residual stress and generation of tensile residual stress, which lead to breakage. In order to suppress the temperature rise of the workpiece, the present inventors have increased the cooling water flow rate to 100 L/min, which is five or more times the conventional flow rate. This enables an ultra-high speed grinding process for the truncation surface under the conditions of a cutting depth of 6 μm or more and a feed rate of 400 mm/min or more, without raising the temperature of the workpiece. This ultra-high speed grinding process can impart a compressive residual stress of 1.50 GPa or more to the truncation surface of a mold for a high pressure generating device. The method for processing the truncation surface described above has been newly found by the present inventors. As a result, a compressive residual stress of 1.50 GPa or more can be imparted to the truncation surface, which has completed the present disclosure.

In the above shot blasting or the above shot peening, hard powder is injected onto the truncation surface using a shot blasting device or a shot peening device to impart compressive residual stress to the truncation surface. As the hard powder, fine particles with an average particle size of 0.05 mm to 1 mm made of cemented carbide or amorphous alloy are used. The injection pressure is 0.6 MPa or more, and the processing time is 30 seconds or more. Shot particles with a Vickers hardness of 13 Hv or more are used when made of cemented carbide, and shot particles with a Vickers hardness of 18 Hv or more are used for amorphous alloy particles. This can impart a compressive residual stress of 1.50 GPa or more to the truncation surface. An injection pressure of less than 0.6 MPa cannot impart a compressive residual stress of 1.5 GPa or more. When the hard powder has an average particle size of more than 1 mm, it is not possible to impart a compressive residual stress of 1.5 GPa or more.

The conventional shot blasting or shot peening used shot particles made of steel or oxide ceramics such as mullite, alumina, and silica from the viewpoint of economy. These particles had a Vickers hardness of 10 Hv or less or a material specific gravity of 5 g/cm³ or less, and the kinetic energy of the particles when projected was so small that they could not impart a compressive residual stress of 1.50 GPa or more to the truncation surface. As a result of careful examination, the present inventors have newly found a method for imparting high compressive residual stress to the truncation surface through shot blasting or shot peening by using fine particles with an average particle size of 0.05 mm to 1 mm made of cemented carbide or amorphous alloy. As a result, a compressive residual stress of 1.50 GPa or more can be imparted to the truncation surface, which has completed the present disclosure.

[Note 1] In the mold for an ultra-high pressure generating device of the present disclosure, it is preferable that the cemented carbide comprises the first phase and the second phase, and that the content of the first phase in the cemented carbide is 80.0 vol % or more and 98.0 vol % or less and the content of the second phase is 2.0 vol % or more and 20.0 vol % or less.

[Note 2] In the mold for an ultra-high pressure generating device of the present disclosure, it is preferable that the cemented carbide comprises the first phase, the second phase, and the third phase, and that the content of the first phase is 80.0 vol % or more and less than 98.0 vol %, the content of the second phase is 2.0 vol % or more and less than 20.0 vol %, and the content of the third phase is more than 0 vol % and 0.5 vol % or less in the cemented carbide.

### EXAMPLES

The present embodiment will be described more specifically with reference to examples. However, the present embodiment is not limited by these examples.

### <Production of Mold for Ultra-High Pressure Generating Device>

Tungsten carbide powder (average grain size (FSSS method) 0.1 to 0.2 μm, carbonization temperature 1400° C.), cobalt (Co) powder (average grain size 0.8 μm), chromium carbide (Cr₃C₂) powder (average grain size 1.0 μm), and vanadium carbide (VC) powder (average grain size 0.9 μm) were mixed using a ball mill to obtain a mixed powder. The mixing conditions are: a media diameter of 6 mm, a rotation speed of 60 rpm, a mixing time of 20 hours, and wet mixing. The content of each powder in the mixed powder was adjusted so that the contents of the first phase, the second phase, the third phase, and Co in the sintered cemented carbide were “First phase (vol %)”, “Second phase (vol %)”, “Third phase (vol %)”, and “Co (mass %)” in Table 1. The average grain size of the tungsten carbide powder was selected so that the average grain size of the tungsten carbide grains in the sintered cemented carbide was “WC grain average grain size (μm)” of “Cemented carbide” in Table 1.

The mixed powder was press-molded at a pressure of 1000 kg/cm² to obtain a molded body. The molded body was heated to 1350° C. in vacuum and sintered for 1 hour. Thereafter, HIP treatment was performed under the conditions of 1350° C., 100 MPa, and 1 hour, and then cooled to obtain a cemented carbide. The cemented carbide has the shape shown in FIG. 1. Specifically, it is a cube of 15 mm wide×15 mm long×15 mm thick, with one of the vertices shaved off, and has a truncation surface.

Grinding process or shot blasting was performed on the truncation surface of the obtained cemented carbide to obtain a mold for an ultra-high pressure generating device for each sample. For each sample, a plurality of molds for an ultra-high pressure generating device were prepared.

For Sample 1, Sample 2, and Sample 4 to Sample 14, grinding process was performed. For Sample 1, Sample 2, Sample 4 to Sample 7, and Sample 10 to Sample 14, a diamond grinding wheel (for example, #200 grade) was used with a cutting depth of 6 μm to 15 μm and a feed rate of 400 mm/min to 800 mm/min. For Sample 8 and Sample 9, a diamond grinding wheel (for example, #200 grade) was used with a cutting depth of 1 μm and a feed rate of 70 mm/min.

For Sample 3, shot blasting was performed. The shot blasting conditions were as follows: using cemented carbide particles with an average particle size of 0.1 mm as the hard powder, with an injection pressure of 1 MPa, and a processing time of 5 minutes.

TABLE 1

| | | Cemented carbide | | | | | | | | | |
|---|---|---|---|---|---|---|---|---|---|---|---|
| | | | WC | | | | | Compressive | | | |
| | | | grain | First | | | | residual | | | Lifespan |
| | Compressive | | average | phase + | | | | stress of | | | (relative |
| | stress | First | grain | second | Second | Third | | truncation | Vickers | Bending | value with |
| Sample | imparting | phase | size | phase | phase | phase | Co | surface | hardness | strength | Sample 8 |
| No. | step | (vol %) | (μm) | (vol %) | (vol %) | (vol %) | (mass %) | (GPa) | (Hv) | (GPa) | as 1.0) |
| 1 | Grinding | 94.6 | 0.15 | 5.4 | 5.3 | 0.1 | 3.0 | 1.78 | 2050 | 2.5 | 1.8 |
| | process | | | | | | | | | | |
| 2 | Grinding | 85.9 | 0.50 | 14.1 | 14.0 | 0.1 | 8.0 | 1.50 | 2000 | 4.2 | 2.8 |
| | process | | | | | | | | | | |
| 3 | Shot blasting | 90.1 | 0.20 | 9.9 | 9.7 | 0.2 | 5.5 | 1.95 | 2100 | 3.6 | 8.0 |
| 4 | Grinding | 95.1 | 0.30 | 4.9 | 4.4 | 0.5 | 2.5 | 1.85 | 2200 | 2.2 | 0.8 |
| | process | | | | | | | | | | |
| 5 | Grinding | 82.5 | 0.30 | 17.5 | 15.8 | 1.7 | 9.0 | 2.03 | 1960 | 4.3 | 0.7 |
| | process | | | | | | | | | | |
| 6 | Grinding | 89.1 | 0.10 | 10.9 | 10.5 | 0.4 | 6.0 | 1.65 | 2230 | 4.2 | 8.8 |
| | process | | | | | | | | | | |
| 7 | Grinding | 88.4 | 0.60 | 11.6 | 10.5 | 1.1 | 6.0 | 1.64 | 1900 | 3.5 | 0.8 |
| | process | | | | | | | | | | |
| 8 | Grinding | 89.3 | 0.20 | 10.7 | 10.5 | 0.2 | 6.0 | 1.15 | 1920 | 3.9 | 1.0 |
| | process | | | | | | | | | | |
| 9 | Grinding | 84.5 | 0.50 | 15.5 | 14.0 | 1.5 | 8.0 | 1.05 | 2000 | 4.2 | 0.8 |
| | process | | | | | | | | | | |
| 10 | Grinding | 94.5 | 0.50 | 5.5 | 5.3 | 0.2 | 3.0 | 1.85 | 2050 | 2.3 | 1.9 |
| | process | | | | | | | | | | |
| 11 | Grinding | 95.5 | 0.15 | 4.5 | 4.4 | 0.1 | 2.5 | 1.78 | 2050 | 2.5 | 1.1 |
| | process | | | | | | | | | | |
| 12 | Grinding | 85.1 | 0.50 | 14.9 | 14.9 | 0.0 | 8.5 | 1.50 | 2000 | 4.2 | 2.0 |
| | process | | | | | | | | | | |
| 13 | Grinding | 89.4 | 0.08 | 10.6 | 10.5 | 0.1 | 6.0 | 1.65 | 2230 | 4.2 | 5.5 |
| | process | | | | | | | | | | |
| 14 | Grinding | 85.5 | 0.55 | 14.5 | 14.0 | 0.5 | 8.0 | 1.50 | 2000 | 4.2 | 2.5 |
| | process | | | | | | | | | | |

### Evaluation

### <Content of First Phase, Content of Second Phase, Content of Third Phase, and Cobalt Content>

For each sample, the content of the first phase and the total content of the second phase and the third phase in the cemented carbide were measured by performing image processing on a backscattered electron image of a cross section of the cemented carbide. The results are shown in “First phase (vol %)” and “Second phase+third phase (vol %)” columns of “Cemented carbide” in Table 1.

For each sample, the content of the third phase in the cemented carbide was obtained by calculating the amount of precipitation of atoms constituting the third phase from the amount of solid solution of such atoms into cobalt constituting the second phase. The results are shown in “Third phase (vol %)” column of “Cemented carbide” in Table 1.

For each sample, the content of the second phase in the cemented carbide was obtained by subtracting the above “Third phase (vol %)” from the above “Second phase+third phase (vol %)”. The results are shown in “Second phase (vol %)” column of “Cemented carbide” in Table 1.

For each sample, the cobalt content of the cemented carbide was obtained by analysis by TAS 0054:2017 cobalt potentiometric titration method for cemented carbide. The results are shown in “Co (mass %)” column of “Cemented carbide” in Table 1.

### <Average Grain Size of Tungsten Carbide Grains>

For each sample, the average grain size of the tungsten carbide grains was measured. A specific measurement method has already been described in Embodiment 1 and the description thereof will not be repeated. The results are shown in “WC grain average grain size (μm)” column in Table 1.

### <Vickers Hardness>

For each sample, the Vickers hardness of the cemented carbide was measured. A specific measurement method has already been described in Embodiment 1 and the description thereof will not be repeated. The results are shown in “Vickers hardness (Hv)” column in Table 1.

### <Bending Strength>

For each sample, the bending strength of the cemented carbide was measured.

A specific measurement method has already been described in Embodiment 1 and the description thereof will not be repeated. The results are shown in “Bending strength (GPa)” column in Table 1.

### <Compressive Residual Stress of Truncation Surface>

For each sample, the compressive residual stress of the truncation surface was measured. A specific measurement method has already been described in Embodiment 1 and the description thereof will not be repeated. The results are shown in “Compressive residual stress of truncation surface (GPa)” column in Table 1.

### <Lifespan>

For each sample, eight molds for an ultra-high pressure generating device were used to produce a multi-anvil. With a multi-anvil type high pressure generating device using the multi-anvil, graphite powder was subjected to high-temperature and high-pressure treatment under the conditions of 16 GPa and 2200° C. to produce diamond. For each sample, using the same multi-anvil, the production of diamond described above was performed a plurality of times, and the number of times of production when breakage occurred in one or more molds for an ultra-high pressure generating device was defined as the lifespan for evaluation. For example, in a case where breakage occurred in one or more molds for an ultra-high pressure generating device during the fifth production of diamond, the lifespan of the multi-anvil is five times. The ratio of the lifespan of each sample when the lifespan of Sample 8 is set to 1.0 is shown in “Lifespan” column in Table 1. For example, Sample 1 has a lifespan of “1.8”. This means that the lifespan of Sample 1 is 1.8 times that of Sample 8. A larger numerical value in the Lifespan column indicates a longer lifespan.

### Discussion

Sample 1 to Sample 3, Sample 6, and Sample 10 to Sample 14 correspond to Examples. Sample 4, Sample 5, and Sample 7 to Sample 9 correspond to Comparative Examples. It was confirmed that Sample 1 to Sample 3, Sample 6, and Sample 10 to Sample 14 (Examples) had longer lifespan than Sample 4, Sample 5, and Sample 7 to Sample 9 (Comparative Examples).

Although the embodiments and Examples of the present disclosure have been described above, it has been planned from the beginning that the configurations of the embodiments and Examples described above may be appropriately combined or modified in various ways.

It should be understood that the embodiments and Examples disclosed herein are illustrative in all respects and are not restrictive. The scope of the present invention is defined not by the above-described embodiments and Examples but by the claims, and is intended to include meanings equivalent to the claims and all modifications within the scope.

### REFERENCE SIGNS LIST

1 anvil; 2 truncation surface

1. A mold for an ultra-high pressure generating device being composed of a cemented carbide,
wherein the cemented carbide comprises a first phase being composed of a plurality of tungsten carbide grains and a second phase containing cobalt,
wherein a Vickers hardness of the cemented carbide is 2000 Hv or more,
wherein a bending strength of the cemented carbide is 2.3 GPa or more,
wherein the mold for an ultra-high pressure generating device has a truncation surface, and
wherein a compressive residual stress of the truncation surface is 1.50 GPa or more.

2. The mold for an ultra-high pressure generating device according to claim 1, wherein a cobalt content of the cemented carbide is 3.0 mass % or more and 8.0 mass % or less.

3. (canceled)

4. The mold for an ultra-high pressure generating device according to claim 1, wherein the cobalt content of the cemented carbide is 4.0 mass % or more and 7.5 mass % or less.

5. The mold for an ultra-high pressure generating device according to claim 1, wherein the cobalt content of the cemented carbide is 5.0 mass % or more and 7.0 mass % or less.

6. The mold for an ultra-high pressure generating device according to claim 1, wherein the Vickers hardness of the cemented carbide is 2000 Hv or more and 3000 Hv or less.

7. The mold for an ultra-high pressure generating device according to claim 1, wherein the Vickers hardness of the cemented carbide is 2050 Hv or more and 3000 Hv or less.

8. The mold for an ultra-high pressure generating device according to claim 1, wherein the bending strength of the cemented carbide is 2.3 GPa or more and 6.0 GPa or less.

9. The mold for an ultra-high pressure generating device according to claim 1, wherein the bending strength of the cemented carbide is 2.7 GPa or more and 6.0 GPa or less.

10. The mold for an ultra-high pressure generating device according to claim 1, wherein the tungsten carbide grains have an average grain size of 0.05 μm or more and 0.50 μm or less.

11. The mold for an ultra-high pressure generating device according to claim 1, wherein the tungsten carbide grains have an average grain size of 0.10 μm or more and 0.40 μm or less.

12. The mold for an ultra-high pressure generating device according to claim 1, wherein the compressive residual stress of the truncation surface is 1.50 GPa or more and 3.00 GPa or less.

13. The mold for an ultra-high pressure generating device according to claim 1, wherein the compressive residual stress of the truncation surface is 1.80 GPa or more and 3.00 GPa or less.

14. The mold for an ultra-high pressure generating device according to claim 1, wherein a content of the first phase in the cemented carbide is 80.0 vol % or more and 98.0 vol % or less.

15. The mold for an ultra-high pressure generating device according to claim 1, wherein a content of the second phase in the cemented carbide is 2.0 vol % or more and 20.0 vol % or less.
